(19) United States
(12) Patent Application Publication
(10) Pub. No.: US 2025/0218447 A1
(43) Pub. Date: Jul. 3, 2025

(54) METHOD AND DEVICE FOR TRANSMITTING AND RECEIVING SIGNALS IN REMOTE ANC SYSTEM

(71) Applicants: Hyundai Motor Company, Seoul (KR); Kia Corporation, Seoul (KR); ARE Corp., Daejeon (KR)

(72) Inventors: Chi Sung OH, Hwaseong-si (KR); Kaang Dok YEE, Yongin-si (KR); Hyoun Suk KIM, Daejeon (KR)

(73) Assignees: Hyundai Motor Company, Seoul (KR); Kia Corporation, Seoul (KR); ARE Corp., Daejeon (KR)

(21) Appl. No.: 18/968,410

(22) Filed: Dec. 4, 2024

(30) Foreign Application Priority Data
Dec. 29, 2023 (KR) 10-2023-0196358

(51) Int. Cl. G10L 19/008; G10K 11/178; G10L 19/032

(52) U.S. Cl. CPC G10L 19/008; G10K 11/17854; G10K 11/17881; G10L 19/032; G10K 2210/1282; G10K 2210/3026; G10K 2210/3027; G10K 2210/3028

(57) ABSTRACT

In a method and device for transmitting and receiving signals in a remote ANC system, the method for transmitting and receiving a multi-channel signal between a vehicle and a server in a remote active noise cancelling (ANC) system includes compressing, by the vehicle, a multi-channel signal including at least one reference signal, at least one noise control signal, and at least one error signal for each channel using adaptive differential pulse code modulation (ADPCM); constructing, by the vehicle, a packet including a signal compressed for each channel, corresponding channel information, and corresponding ADPCM status information, for each predetermined transmission unit; transmitting, by the vehicle, the constructed packet to a server; and restoring, by the server, the signal compressed for each channel based on the received packet.

### CROSS-REFERENCE TO RELATED APPLICATIONS

The present application claims priority to Korean Patent Application No. 10-2023-0196358, filed Dec. 29, 2023, the entire contents of which is incorporated herein for all purposes by this reference.

### BACKGROUND OF THE PRESENT DISCLOSURE

### Field of the Present Disclosure

The present disclosure relates to a method and device for transmitting and receiving signals in a remote ANC system. In the remote ANC system, it relates to a technology in which a vehicle compresses and transmits signals for each channel and a server restores the received signal for each channel.

### Description of Related Art

The statement herein merely provides background information related to the present disclosure and may not necessarily form the related art.

When a vehicle travels, noise caused by air and structural noise are generated in the vehicle. For example, there are noise generated by an engine of the vehicle, noise generated by friction between the vehicle and a road surface, vibration transferred through a suspension, wind noise generated by wind, and the like.

Methods of reducing such noise include a passive noise control method in which a sound absorbing material that absorbs noise is provided inside the vehicle, and an active noise control (ANC) method that utilizes a noise control signal having an antiphase with respect to the noise.

Since the passive noise control method has limitations in adaptively removing various noises, research on the active noise control method is actively underway. A road-noise active noise control (RANC) method for removing road noise in a vehicle is attracting attention.

To perform the active noise control, a noise control system of a vehicle generates a noise control signal having the same amplitude as internal noise of the vehicle, but an antiphase with respect to a phase of the internal noise, and outputs the noise control signal to the interior of the vehicle, canceling out the internal noise.

However, there are limits for a controller included in the vehicle to perform all active noise control due to low performance of the controller.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a remote ANC system including a remote server that is configured to perform update of an adaptive filter, and a vehicle that generates a noise control signal using the updated adaptive filter, and a method of operating the same.

The exemplary embodiments of the present disclosure provide a method and device for compressing a signal for each channel using ADPCM and transmitting corresponding channel information and ADPCM status information along with the compressed signal in a remote ANC system.

The problems to be solved by the present disclosure are not limited to the problems mentioned above, and other problems not mentioned will be clearly understood by those skilled in the art from the description below.

According to at least an exemplary embodiment of the present disclosure, the present disclosure provides a method for transmitting and receiving a multi-channel signal between a vehicle and a server in a remote active noise cancelling (ANC) system including compressing, by the vehicle, a multi-channel signal including at least one reference signal, at least one noise control signal, and at least one error signal for each channel using adaptive differential pulse code modulation (ADPCM); constructing, by the vehicle, a packet including a signal compressed for each channel, corresponding channel information, and corresponding ADPCM status information, for each predetermined transmission unit; transmitting, by the vehicle, the constructed packet to a server; and restoring, by the server, the signal compressed for each channel based on the received packet.

According to another exemplary embodiment of the present disclosure, the present disclosure provides a device for transmitting a multi-channel signal included in a vehicle in a remote active noise cancelling (ANC) system including: a memory configured to store instructions; and at least one processor, wherein the at least one processor executes the instructions to compress a multi-channel signal including at least one reference signal, at least one noise control signal, and at least one error signal for each channel using adaptive differential pulse code modulation (ADPCM), construct a packet including a signal compressed for each channel, corresponding channel information, and corresponding ADPCM status information for each predetermined transmission unit, and transmit the constructed packet to a server.

According to another exemplary embodiment of the present disclosure, the present disclosure provides a device for receiving a multi-channel signal included in a server in a remote active noise cancelling (ANC) system including a memory configured to store instructions; and at least one processor, wherein the at least one processor executes the instructions to receive packets from at least one vehicle, and restore a signal compressed for each channel based on the received packets.

As described above, according to an exemplary embodiment of the present disclosure, it is possible to prevent update delay of the adaptive filter and to improve noise control performance by distributing a noise control algorithm to the vehicle and the server.

According to another exemplary embodiment of the present disclosure, it is possible to reduce the amount of data transmission by compressing and transmitting signals between the vehicle and the server in the remote ANC system.

According to another exemplary embodiment of the present disclosure, it is possible to improve the accuracy of update of the adaptive filter by sharing ADPCM status information related to signal compression in a remote ANC system between the vehicle and the server.

The effects of the present disclosure are not limited to the effects mentioned above, and other effects not mentioned may be clearly understood by those skilled in the art from the description below.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a schematic diagram illustrating components of a vehicle according to an exemplary embodiment of the present disclosure.

FIG. 2 is a diagram illustrating a noise control method according to an exemplary embodiment of the present disclosure.

FIG. 3 is a schematic diagram of a noise control algorithm according to an exemplary embodiment of the present disclosure.

FIG. 4 is a diagram illustrating a remote ANC system according to an exemplary embodiment of the present disclosure.

FIG. 5 is a schematic diagram of the remote ANC system according to an exemplary embodiment of the present disclosure.

FIG. 6A and FIG. 6B are simplified block diagrams of an ADPCM encoder and an ADPCM decoder, respectively.

FIG. 7 is a flowchart of a method for transmitting and receiving signals between a vehicle and a server in the remote ANC system according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In the following description, like reference numerals designate like elements, although the elements are shown in different drawings. Furthermore, for clarity and for brevity, the following description of various exemplary embodiments will omit a detailed description of related known components and functions when considered obscuring the subject of the present disclosure.

Various ordinal numbers or alpha codes such as first, second, i), ii), a), b), etc., are prefixed solely to differentiate one component from the other but not to imply or suggest the substances, order, or sequence of the components. Throughout the present specification, when a part “includes” or “comprises” a component, the part is meant to further include other components, to not exclude thereof unless specifically stated to the contrary. The terms such as “unit,” “module,” and the like refer to units in which at least one function or operation is processed and they may be implemented by hardware, software, or a combination thereof.

The description of the present disclosure to be presented below in conjunction with the accompanying drawings is intended to describe exemplary embodiments of the present disclosure and is not intended to represent the only embodiments in which the technical idea of the present disclosure may be practiced.

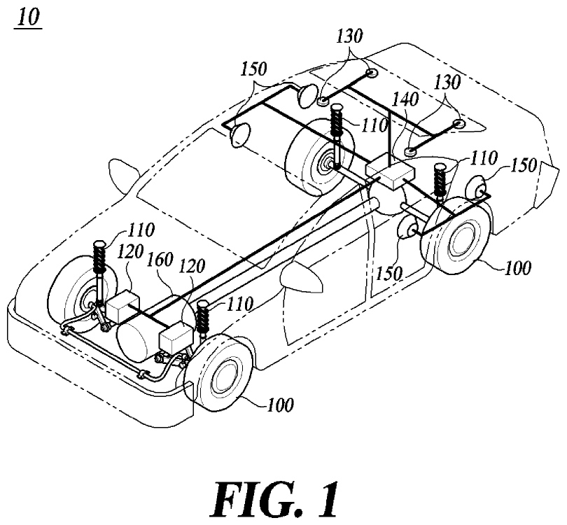

FIG. 1 is a schematic diagram illustrating components of a vehicle according to an exemplary embodiment of the present disclosure.

Referring to FIG. 1, a vehicle 10 including wheels 100, suspension devices 110, reference sensors 120, microphones 130, a controller 140, speakers 150, and axle 160 is shown. In FIG. 1, the number and disposition positions of a plurality of components correspond to an exemplary embodiment of the present disclosure, and the number and positions of the components may vary in other exemplary embodiments of the present disclosure.

The vehicle 10 includes a chassis on which accessories necessary for traveling are mounted, and a noise control system that is configured to perform active noise control. The vehicle 10 may further include at least one of a driving device, a steering device, and a braking device.

The chassis of the vehicle 10 includes wheels 100 of the vehicle 10, and the wheels 100 include front wheels disposed on the left and right sides of the front, and rear wheels disposed on the left and right sides of the rear of the vehicle 10. The chassis of the vehicle 10 may further include the axle 160 as a power transmission means, the suspension devices 110 as vibration alleviation means, and a body. Here, the suspension devices 110 are devices that alleviate vibration or impact of the vehicle 10. While the vehicle 10 is traveling, vibration due to a road surface is applied to the vehicle 10. The suspension devices 110 alleviate vibration applied to the vehicle 10 using springs, air suspension, or the like. The suspension devices 110 can improve riding comfort of occupants riding in the vehicle 10 by alleviating the impact.

However, noise may be generated inside the vehicle 10 by the suspension devices 110. The suspension devices 110 can alleviate large vibration applied to the vehicle 10, but it is difficult to eliminate micro vibration caused by friction between the wheels 100 and the road surface. These micro vibrations generate noise inside the vehicle 10 through the suspension devices 110. Furthermore, noise generated by friction between the wheels 100 and the road surface, noise generated by an engine as a power apparatus, or wind noise generated by wind may flow into the interior of the vehicle 10.

To eliminate noise inside the vehicle 10, the vehicle 10 may include a noise control system. The noise control system of the vehicle 10 can attenuate noise inside the vehicle 10 using the noise control signal including the same amplitude as and an antiphase with respect to a noise signal for the noise inside the vehicle 10.

For the present purpose, the noise control system includes the reference sensors 120, the microphones 130, the controller 140, and the speakers 150. The noise control system may further include an amplifier (AMP) for audio playback.

The reference sensors 120 generate a reference signal representing vibration caused by friction between the wheels 100 and the road surface, and transmit the reference signal to the controller 140. In the instant case, the reference sensors 120 transmit the reference signal in a form of an analog signal to the controller 140. As an alternative, the reference sensors 120 may convert the reference signal into a digital signal and transmit the converted digital signal to the controller 140.

Here, the reference sensors 120 may be accelerometers. The accelerometer is a device that generates an acceleration signal representing an acceleration of the vehicle 10. The accelerometer is used to measure the vibration of the vehicle 10. In other words, the reference sensors 120 may be configured to generate reference signals according to the vibration of the vehicle 10, and the reference signals represent acceleration signals. The reference sensors 120 are three-axis accelerometers and can measure vibration along three vertical axes.

The reference sensors 120 may be disposed on the suspension devices 110, on a connection mechanism that connects the wheels 100 to the axle 160, or on a vehicle body.

The noise control system may use at least one of a gyro sensor, a motion sensor, a displacement sensor, a torque sensor, and a microphone as the reference sensor to measure the vibration of the vehicle 10.

The microphones 130 detect sound inside the vehicle 10. The microphones 130 may detect noise inside the vehicle 10. For example, the microphones 130 can measure sound pressure at about 20 Hz to 20 kHz that are an audible frequency band of human. A range of listening frequencies of the microphones 130 may be narrower or wider. In an exemplary embodiment of the present disclosure, the microphones 130 may measure noise flowing into the vehicle 10 due to friction between the wheels 100 and the road surface.

When the noise control signal is output to the interior of the vehicle 10 for noise control, the microphones 130 can measure a noise signal remaining inside the vehicle 10 in an environment in which the noise inside the vehicle 10 is removed by the noise control signal. The residual noise is measured as an error signal or residual signal by the microphones 130. The error signal may be used as information for determining whether noise inside the vehicle 10 has been normally reduced or eliminated.

When audio signals are further output to the interior of the vehicle 10, acoustic signals from the microphones 130 may include the error signal and the audio signal.

The controller 140 generates the noise control signal for removing noise inside the vehicle based on the reference signal of the reference sensors 120 and the error signal. The controller 140 may be configured to generate a noise control signal that includes the same amplitude as the noise signal but includes an antiphase with respect to the noise signal. The controller 140 can convert the reference signal and the error signal, which are analog signals, into digital signals and generate the noise control signal from the converted digital signals.

When the noise control system includes an amplifier, the amplifier receives the noise control signal from the controller 140, receives an audio signal from an audio, video, navigation (AVN) device, mixes the noise control signal with the audio signal, and outputs a mixed signal through the speaker.

The amplifier can adjust an amplitude of the mixed signal using amplification circuits. The amplification circuits may include vacuum tubes or transistors for amplifying a power of the mixed signal.

The speakers 150 receive a mixed signal, which is an electrical signal, from the amplifier or the noise control signal from the controller 140, and output the mixed signal or noise control signal inside the vehicle 10 in a form of a sound wave. Noise inside the vehicle 10 may be reduced or eliminated by the mixed output of the speakers 150, and noise may be reduced as much as possible at the position of the microphones 130 or the ear of the occupant.

The speakers 150 may output the noise control signals only to a specific occupant. The speakers 150 output different phases of noise control signals at a plurality of positions inside the vehicle 10, causing constructive interference or destructive interference at a position of an ear of a specific occupant.

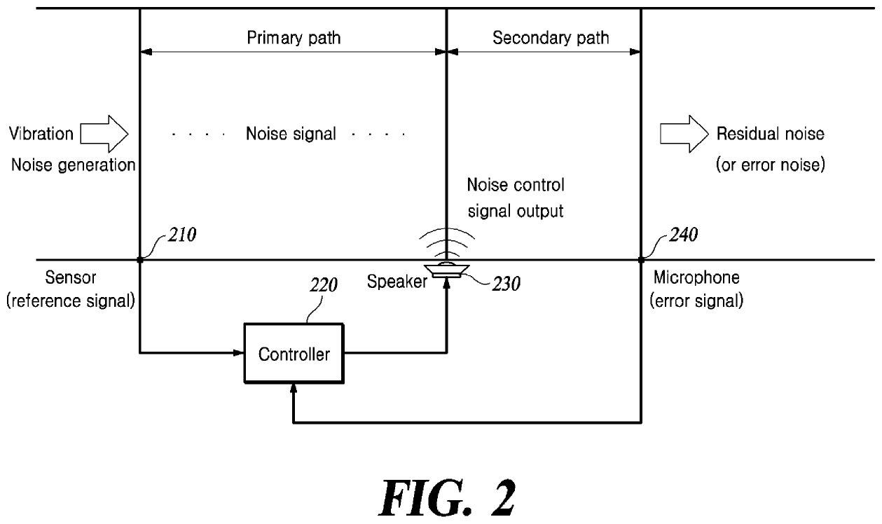

FIG. 2 is an illustrative diagram illustrating a noise control method according to an exemplary embodiment of the present disclosure.

Referring to FIG. 2, the vehicle noise control system includes a sensor 210, a controller 220, a speaker 230, and a microphone 240.

The noise control system of the vehicle eliminates noise in the vehicle by outputting the noise control signal generated based on the reference signal from the sensor 210. Here, the noise control signal is a signal that includes the same amplitude as the noise signal, but includes an inverse phase to the phase of the noise signal. Furthermore, the noise control system can also remove residual noise inside the vehicle by use of the residual noise remaining after noise removal as feedback.

Vibration is generated due to friction between the vehicle and the road surface while the vehicle is traveling, and the generated vibration causes noise inside the vehicle. The vibration is measured as an electrical signal by the sensor 210.

The controller 220 receives the reference signal measured by the sensor 210.

The controller 220 generates the noise control signal for attenuating the noise inside the vehicle by applying an adaptive filter to the reference signal. The controller 220 is configured to determine filter coefficients of an adaptive filter (often referred to as a W-filter) based on the error signal(s) and reference signal(s) according to an algorithm such as least mean square (LMS) or filtered-x least mean square (FxLMS) well known in the art. Thereafter, the controller 220 generates the noise control signal by applying the filter coefficients to the obtained reference signal. The reference signal becomes the noise control signal through convolution computation with the filter coefficients.

The controller 220 outputs the noise control signal through the speaker 230. When the noise control signal is played through the speaker 230, a sound pressure level of the road noise at the position of the speaker 230 is reduced.

Meanwhile, a path between the sensor 210 and the speaker 230 is called a primary path or main sound path. The primary path is a model representing acoustic transfer characteristic from the sensor 210 to the speaker 230.

In the instant case, residual noise may occur at a listening position of the occupant due to a difference in distance between the position of the speaker 230 that outputs the noise control signal and the position of the ear of the occupant. For example, because the noise control signal output from the speaker 230 changes while being propagated to the listening position of the occupant, noise may not be completely removed from the position the ear of the occupant. Furthermore, because the noise control signal generated by the controller 220 changes while passing through the amplifier or speaker 230, this may be different from the noise at the listening position of the occupant. This residual noise may be expressed as an error signal representing a difference between the noise signal and the changed noise control signal at the listening position of the occupant.

To remove the residual noise, the noise control system may include a microphone 240 near to the position of the ear of the occupant, and may estimate that a signal measured by the microphone 240 is the residual noise. Here, a path between the speaker 230 and the microphone 240 is called a secondary path. The noise control system may store a transfer function for the secondary path between the speaker 230 and the microphone 240 in advance.

The controller 220 receives the error signal fed back from the microphone 240 and updates the filter coefficients of the adaptive filter using acoustic transfer characteristic of the secondary path, the reference signal, and the error signal. The controller 220 generates a noise control signal by applying the updated coefficients of the adaptive filter to the reference signal. The noise control signal includes an ideal waveform so that, when the noise control signal is played by the speaker 250 via an amplifier, an offset sound including a substantial antiphase with respect to and the same size as road noise heard by the occupant in the vehicle cabin is generated at a place close to the microphone 240. An offset sound from the speaker 230 meets the road noise near to the microphone 240 in the vehicle cabin so that a sound pressure level caused by the road noise may be lowered at the present position. That is, the noise control signal based on the secondary path can reduce noise and residual noise at the position of the microphone 240. When the microphone 240 is closer to a listening position of the occupant, the microphone 240 can measure noise closer to the residual noise at the listening position of the occupant. When the microphone 240 is disposed at a place close to the position of the ear of the occupant, this is advantageous to remove the residual noise.

Meanwhile, the noise control system of the vehicle can more accurately model the secondary path using a virtual microphone. The controller 220 can generate a virtual microphone at the position of the ear of the occupant, and obtain accurate information for acoustic transfer characteristic between the speaker 230 and the listening position of the occupant based on the signal measured by the virtual microphone. The secondary path may include a path between the speaker 230 and the microphone 240 and a path between the microphone 240 and the virtual microphone.

Through the above process, the noise control system of the vehicle can further attenuate residual noise at the position of the ear of the occupant, and the performance of active noise control may be improved.

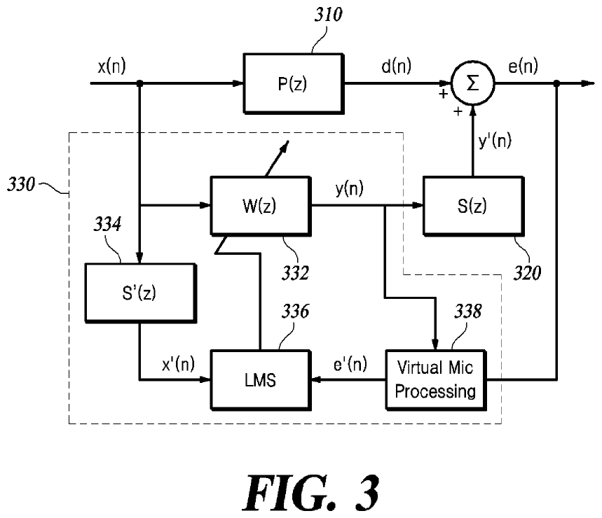

FIG. 3 is a schematic diagram of a noise control algorithm according to an exemplary embodiment of the present disclosure.

Referring to FIG. 3, a primary path 310, a secondary path 320, a controller 330, an adaptive filter 332, a secondary path model 334, an adaptive filter controller 336, and a virtual error signal estimator 338 are shown. The controller 330 is a device included in the vehicle.

The noise control algorithm shown in FIG. 3 relates to a single-channel feedforward FxLMS algorithm. In other exemplary embodiments of the present disclosure, multi-channel structures with many additional channels, many additional microphones, and many additional speakers may also be employed and algorithms for the same may be employed. For example, 12 acceleration sensors and 8 speakers may be used, and a total of 12*8 sets of filter coefficients may be used for the algorithm. Each filter coefficient set includes at least one filter coefficient. Hereinafter, a noise control algorithm based on one sensor and one speaker will be described. Furthermore, n represents a sampling time and z represents a frequency.

A reference signal x(n) is detected by the reference sensor of the vehicle. For example, the reference signal x(n) may be a measurement signal of an accelerometer or a vibration sensor. The reference signal x(n) becomes the noise signal d(n) through the primary path 310. The primary path 310 represents the reference sensor and speaker path. The acoustic transfer characteristic P(z) of the primary path 310 refer to a relationship between the reference signal x(n) and the noise signal d(n). The noise signal d(n) is noise at a position where the controller 330 wants to control. For example, the noise signal d(n) represents noise at the position of the ear of the occupant.

The controller 330 generates the noise control signal y(n) for removing the noise signal d(n) using an adaptive control algorithm. The noise control signal y(n) is a signal for removing or attenuating the noise signal d(n).

As the adaptive control algorithms, the controller 330 may use various algorithms such as Filtered-input Least Mean Square (FxLMS), Filtered-input Normalized Least Mean Square (FxNLMS), Filtered-input Recursive Least Square (FxRLS), and Filtered-input Normalized Recursive Least Square (FxNRLS).

In detail, the controller 330 utilizes the adaptive filter 332, the secondary path model 334, and the adaptive filter controller 336 to generate the noise control signal y(n). First, the adaptive filter 332 receives the reference signal x(n) and generates the noise control signal y(n) for removing the noise signal d(n). A transfer function of the adaptive filter 332 may be expressed as W(z), and the transfer function W(z) of the adaptive filter 332 may represent at least one filter coefficient. The noise control signal y(n) may be derived by convolution computation between the reference signal x(n) and the transfer function W(z) of the adaptive filter 332.

The noise control signal y(n) is output through the speaker and is transformed as noise control signal y(n) passes through the secondary path 320. Here, when the position of the ear of the occupant is treated as the same as the position of the microphone, the secondary path 320 is a path between the speaker and the microphone. That is, the noise control signal y(n) becomes the transformed noise control signal y′(n) at the position of the physical microphone. The transformed noise control signal y′(n) and the noise signal d(n) cancel each other out at the position of the physical microphone. However, even when the noise control signal y(n) at the position of the speaker is generated to be the same as the noise signal d(n), the noise control signal y′(n) transformed through the secondary path 320 is different from d(n), and thus, residual noise is generated at the position of the physical microphone.

The residual noise at the physical microphone position is measured as the error signal e(n) by the physical microphone. Here, the error signal e(n) represents residual noise remaining after the noise signal d(n) is canceled out by the noise control signal y(n) at a noise control point such as the physical microphone position.

To remove the error signal e(n), the controller 330 may update filter coefficients of the adaptive filter 332 based on the reference signal x(n) and the error signal e(n). In other words, the adaptive filter controller 336 implemented on the controller 330 updates the filter coefficients by considering that the noise control signal y(n) is transformed by the secondary path 320 after the noise control signal y(n) is output from the speaker.

However, the error signal e(n) represents the residual noise measured at the position of the physical microphone and is therefore different from the residual noise at positions of an ear of the occupant. Even though the microphone configured for measuring the error signal e(n) is disposed close to the position of the ear of the occupant, the residual noise at the position of the ear of the occupant is a virtual error signal e′(n) rather than the error signal e(n) due to a difference in distance between the position of the microphone and the position of the ear of the occupant.

Therefore, it is necessary to estimate the virtual error signal e′(n) at the position of the ear of the occupant and remove the virtual error signal e′(n).

First, a transfer function S′(z) of the secondary path model 334, which represents the acoustic transfer characteristic for the secondary path 320, may be estimated in advance. For example, when there is no noise in the vehicle, the secondary path model 334 may be estimated from the output of the speaker and the input of the microphone. In addition to the above-described modeling method, the secondary path 320 may be modeled by an engineer in the noise control field using an appropriate method among modeling methods to best explain a physical phenomenon of an actual audio system.

The controller 330 applies the secondary path model 334 to the reference signal x(n), so that the reference signal x(n) becomes the filtered reference signal x′(n). The filtered reference signal x′(n) is input to the adaptive filter controller 336.

The virtual error signal estimator 338 estimates the virtual error signal e′(n) at the position of the ear of the occupant based on the noise control signal y(n) and the error signal e(n). The virtual error signal estimator 338 may be configured to generate a virtual microphone at the position of the ear of the occupant based on the noise control signal y(n) and the error signal e(n). Unlike a physical microphone, the virtual microphone includes a concept for estimating acoustic signals from the position of the ear of the occupant. The virtual error signal estimator 338 can measure the virtual error signal e′(n) at the position of the ear of the occupant using the virtual microphone.

The virtual error signal estimator 338 stores a first acoustic transfer characteristic from the speaker to the physical microphone, a second acoustic transfer characteristic from the position of the physical microphone to the expected position of the ear of the occupant, and a third acoustic transfer characteristic from the speaker to the expected position of the ear of the occupant in advance. Thereafter, the virtual error signal estimator 338 applies the first acoustic transfer characteristic to the noise control signal y(n) to estimate the transformed noise control signal y′(n) at the position of the physical microphone. The virtual error signal estimator 338 estimates the noise signal d(n) at the position of the physical microphone by subtracting the transformed noise control signal y′(n) from the error signal e(n). Thereafter, the virtual error signal estimator 338 estimates the virtual noise signal d′(n) at the expected position of the ear of the occupant by applying the second acoustic transfer characteristic to the noise signal d(n). Furthermore, the virtual error signal estimator 338 estimates a virtual noise control signal y″(n) at the expected position of the ear of the occupant by applying the third acoustic transfer characteristic to the noise control signal y(n). The virtual noise control signal y″(n) is a signal estimated to include the same magnitude as and an antiphase with respect to the virtual noise signal d′(n) at the expected position of the ear of the occupant. However, the virtual noise signal d′(n) may not be the same as the virtual noise control signal y″(n) due to various factors. Accordingly, the virtual error signal estimator 338 may add the virtual noise signal d′(n) to the virtual noise control signal y″(n) to obtain a virtual error signal e′(n) representing virtual residual noise remaining after the virtual noise signal d′(n) being removed by the virtual noise control signal y″(n).

Therefore, the adaptive filter controller 336 applies a least mean square (LMS) algorithm to the filtered reference signal x′(n) and the virtual error signal e′(n) to update the filter coefficients of the adaptive filter 332. The filter coefficients are updated so that the virtual error signal e′(n) becomes 0. The filter coefficient W(z) may be updated by gradient descent.

The updated adaptive filter 332 generates the noise control signal y(n) from the reference signal x(n). When the noise control signal y(n) is output from the speaker, the virtual error signal e′(n) measured at the virtual microphone position is minimized. That is, noise according to the reference signal x(n) is removed as much as possible at the expected position of the ear of the occupant.

Through the above-described process, the controller 330 can adaptively generate the noise control signal y(n).

Meanwhile, in other exemplary embodiments of the present disclosure, the virtual error signal estimator 338 may be omitted. In the instant case, the adaptive filter controller 336 may update the filter coefficients of the adaptive filter 332 so that the error signal e(n) becomes 0 based on the filtered reference signal x′(n) and the error signal e(n).

Meanwhile, unless the controller 330 included in the vehicle is an expensive digital signal processor, it may be difficult for the controller 330 to perform all of the above-described signal processing due to performance limitations. In the noise control algorithm, the update of the filter coefficients of the adaptive filter 332 requires a largest amount of computation, and convolution computation between the adaptive filter 332 and the reference signal x(n) for generating the noise control signal y(n), and virtual microphone processing computation of the virtual error signal estimator 338 occupy a second high proportion. Filter coefficient update requires a much larger amount of computation than other computations. As an exemplary embodiment of the present disclosure, the filter coefficient update may account for 85 percent of a total amount of computation of the noise control algorithm. There may be a limit for the controller 330 to process all of these computations.

Therefore, according to an exemplary embodiment of the present disclosure, the noise control algorithm can be distributedly processed.

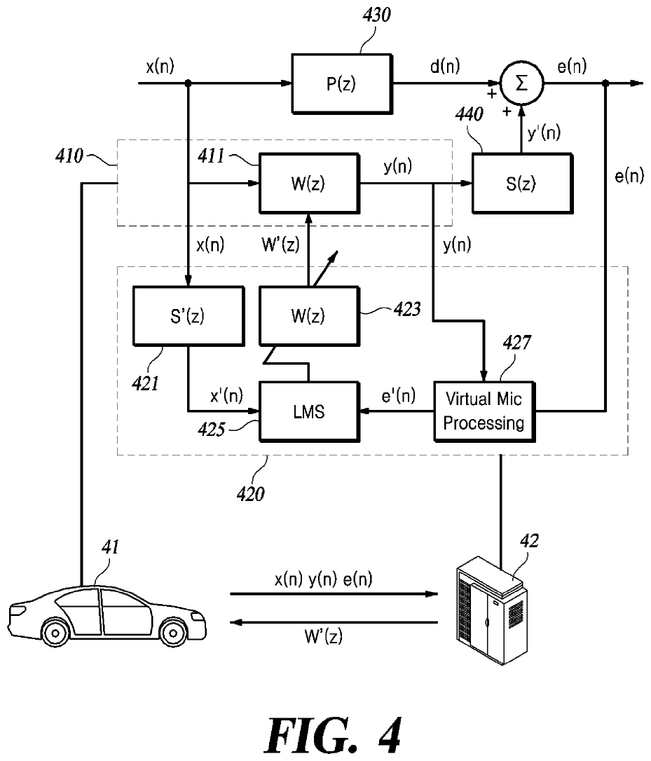

FIG. 4 is a diagram illustrating the remote ANC system according to an exemplary embodiment of the present disclosure.

Referring to FIG. 4, the remote active noise cancelling (ANC) system includes a vehicle 41 and a server 42. The remote ANC system is a system for performing processing with the noise control algorithm distributed to the vehicle 41 and the server 42.

The noise control algorithm shown in FIG. 4 is the same or similar to the noise control algorithm shown in FIG. 3. An adaptive filter controller 425 is configured to perform an operation of the adaptive filter controller 336, and the secondary path model 421 is the same as the secondary path model 334. A primary path 430 is the same as the primary path 310, and a secondary path 440 is the same as the secondary path 320. Furthermore, the virtual error signal estimator 427 is configured to perform a function of the virtual error signal estimator 338. However, the noise control algorithm of FIG. 4 is partially performed not only in the vehicle 41 but also in the server 42.

The vehicle 41 may include a controller 410 with relatively limited performance, and the server 42 may include a computation device 420 with relatively higher performance. Furthermore, the vehicle 41 and the server 42 each include communication devices for wireless communication with each other. The communication devices can perform a variety of communications, including several generations of mobile communication technologies, Local Area Network (LAN) communications, and vehicle-to-everything (V2X) communications. Furthermore, the server 42 may be a cloud computation device, and server 42 may provide a filter coefficient update operation to be described below to numerous vehicles.

First, the reference signal x(n) is collected from the reference sensor of the vehicle 41. The controller 410 in the vehicle 41 generates the noise control signal y(n) by applying a local adaptive filter 411 to the reference signal x(n). At the same time, the error signal e(n) is measured at the microphone in the vehicle 41.

The vehicle 41 transmits the reference signal x(n), the noise control signal y(n), and the error signal e(n) to the server 42.

The computation device 420 in the server 42 updates the filter coefficients of the remote adaptive filter 423 using the reference signal x(n), the noise control signal y(n), and the error signal e(n). The computation device 420 may accelerate processing of the noise control algorithm by performing a filter coefficient update, which takes up the largest amount of computation in the noise control algorithm. Here, since an update process of the remote adaptive filter 423 is the same as a filter coefficient update process of the adaptive filter 332 described in FIG. 3, detailed description thereof will be omitted.

The computation device 420 obtains an updated filter coefficient W′(z) as a result of updating the remote adaptive filter 423, and transmits the updated filter coefficient W′(z) to the controller 410 of the vehicle 41 through wireless communication.

The controller 410 receives the updated filter coefficient W′(z) and replaces the filter coefficient W(z) of the local adaptive filter 411 with the updated filter coefficient W′(z). Thereafter, the reference signal x(n) becomes the noise control signal y(n) through computation with the updated filter coefficient W′(z).

Through repetition of the above-described processes, the vehicle 41 and the server 42 in the remote ANC system can implement the noise control algorithm.

The low-performance controller 410 is configured to perform replacement and application of the local adaptive filter 411 which requires a small amount of computation, and the high-performance computation device 420 is configured to perform a filter coefficient update operation of the adaptive filter controller 425 which requires a large amount of computation. Thus, since the noise control algorithm is distributedly processed, the update of the filter coefficient for the local adaptive filter 411 may be performed rapidly without delay.

Furthermore, it is possible to change adaptive control algorithms of all vehicles connected to the server 42 by changing only an adaptive control algorithm of the adaptive filter controller 425 of the server 42 without changing software of controllers included in all vehicles.

In another exemplary embodiment of the present disclosure, the vehicle 41 may transmit the reference signal x(n) and the error signal e(n) to the server 42, and the server 42 may be configured to generate and return the noise control signal y(n). However, a problem such as low noise control performance due to increased latency and increased latency may occur as compared to a scheme in which the server 42 transmits the updated filter coefficient W′(n).

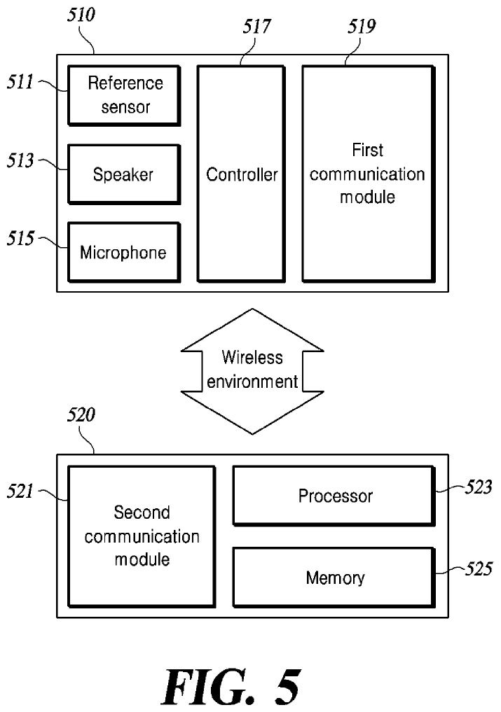

FIG. 5 is a schematic diagram of the remote ANC system according to the exemplary embodiment of the present disclosure.

Referring to FIG. 5, the remote ANC system includes a vehicle 510 and a server 520.

The vehicle 510 includes reference sensors 511, speakers 513, microphones 515, a controller 517, and a first communication module 519. Each of the reference sensors 511 may be an accelerometer, and measures an acceleration signal as a reference signal while the vehicle 510 is traveling. Each of the speakers 513 outputs the noise control signal. Each of the microphones 515 receives the error signal. The controller 517 applies the updated filter coefficient received from the server 520 to the reference signal to generate the noise control signal. The first communication module 519 supports connection for wireless communication with the server 520 and exchanges signals and filter coefficients with the second communication module 521 of the server 520. Furthermore, the first communication module 519 may include a signal buffer for synchronization.

The server 520 includes a second communication module 521, a processor 523, and a memory 525. The second communication module 521 supports wireless communication with the first communication module 519. Furthermore, the second communication module 521 may include a signal buffer for synchronization. The processor 523 updates the remote adaptive filter using the reference signal, the noise control signal, and the error signal received from the vehicle 510. That is, the processor 523 may execute functions of the computation device 420. The memory 525 stores instructions for enabling the processor 523 to perform filter coefficient update.

The server 520 may update the filter coefficient at regular time intervals and periodically. For example, an update period of the filter coefficient may be set to 64 ms. The server 520 may update the filter coefficient every 64 ms based on a signal received from the vehicle 510. When the update period of the filter coefficient in the server 520 is shorter, noise control performance in the vehicle 510 may be further improved.

Meanwhile, to distributedly process the noise control algorithm in the remote ANC system, continuous exchange of various signals and updated filter coefficients between the vehicle 510 and the server 520 is required. An amount of data of the reference signal x(n), the noise control signal y(n), and/or the error signal e(n) transmitted from the vehicle 510 to the server 520 is very large. When a large amount of data is transmitted as is, the overall performance of the remote ANC system may deteriorate due to a transmission delay or error. Therefore, it is necessary to reduce an amount of data transmission.

To the present end, in the remote ANC system according to the exemplary embodiment of the present disclosure, the vehicle 510 compresses a multi-signal including at least one of the reference signal x(n), the noise control signal y(n), and the error signal e(n) and transmits the compressed signal to the server 520. Here, the reference signal includes as many channels as the number (for example, R) of reference sensors 511 disposed in the vehicle 510. Here, the noise control signal includes as many channels as the number (for example, K) of speakers 513 disposed in the vehicle 510. Here, the error signal includes as many channels as the number (for example, M) of microphones 515 disposed in the vehicle 510. That is, the multi-signal may include at least one of R reference channel signals, K noise control channel signals, and M error channel signals.

In the remote ANC system, the reference signal, the noise control signal, and the error signal are compressed and restored for each channel. This is because a correlation between the reference channel signals, the noise control channel signals, and the error channel signals is low. That is, the reference signal, the noise control signal, and the error signal are compressed for each channel in the vehicle 510 and restored for each channel in the server 520.

The remote ANC system may encode or decode the multi-signal using an adaptive differential pulse code modulation (ADPCM) algorithm. The ADPCM is a technology for efficiently compressing a pulse code modulation (PCM) signal using adaptive quantization and differential predictive coding. First, an encoder and a decoder of ADPCM will be briefly described.

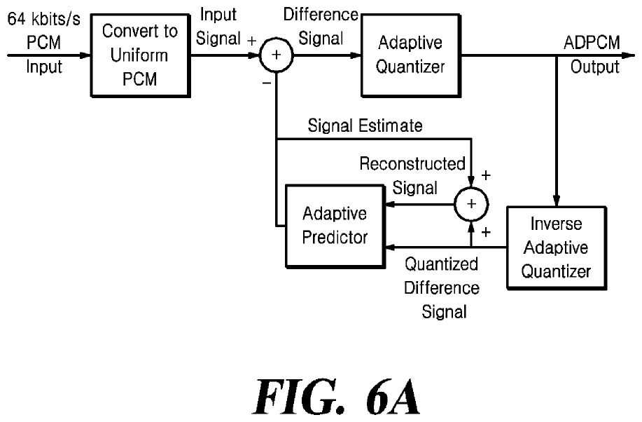

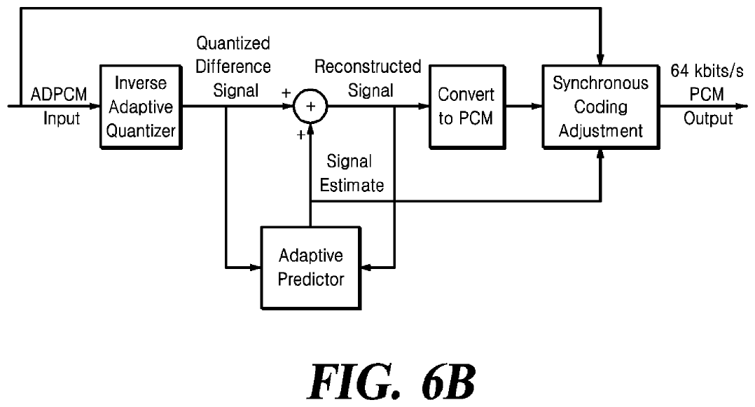

FIG. 6A is a simplified block diagram of a general ADPCM encoder. Referring to FIG. 6A, a sound signal is encoded by obtaining a difference signal between an input signal and a signal estimate and quantizing the difference signal, using characteristics of the sound signal including a high correlation with adjacent sample values. That is, the sound signal may be encoded at a bit rate of 32 kbps (8 kbps×4) by quantizing a difference signal of a 64 kbps (8 kHz×8) PCM input signal in 4 bits.

The ADPCM encoder converts 64 Kbps PCM of law or A law which is an input signal into a uniform PCM signal, and subtracts the prediction signal from the present signal to obtain a difference signal. A 15-level adaptive quantizer is used for quantization of the difference signal, and 4-bit code is assigned to each quantization level. The output signal of the adaptive quantizer becomes an output signal of the ADPCM encoder.

FIG. 6B is a simplified block diagram of a general ADPCM decoder. Referring to FIG. 6B, in the ADPCM decoder, a 4-bit ADPCM encoded signal which is an input signal is converted into a difference signal quantized by a 15-level inverse adaptive quantizer. In an adaptive predictor, a prediction signal may be obtained using the quantized difference signal and the decoded signal of a previous sample. A decoded signal of the input signal may be obtained by adding the prediction signal which is an output of the adaptive predictor to the difference signal. A signal path for performing the determination of the prediction signal in the adaptive predictor is the same as a circuit in the ADPCM encoder.

As described above, ADPCM is a scheme for compressing a difference between a current sample and an immediately previous sample using a quantization step size adaptively found according to a size of the change, and the encoder and decoder internally manage the immediately previous sample value, or the like.

Meanwhile, the remote ANC system requires compression and restoration for each channel of the multi-signal. Incidentally, since the ADPCM generally compresses and restores continuous PCM signals of a single channel, compression may be performed based on new data when the channel of the multi-signal changes, which causes discontinuous points at the time of the compression and restoration in the ADPCM and thus, low accuracy of the restoration. This is because the adaptive predictor of the ADPCM decoder continuously updates information on a difference size of existing data, and an initial PCM output of the decoder becomes different from an actual value due to channel change for the multi-signal.

To solve this, internal information of the adaptive predictor of the encoder is shared with the decoder.

The remote ANC system exchanges channel information and ADPCM status information for each predetermined transmission unit along with a signal compressed for each channel. That is, the vehicle 510 transmits the compressed signal for each channel, the corresponding channel information, and the corresponding ADPCM status information together for each predetermined transmission unit, and the server 520 restores the corresponding compressed signal for each channel based on the received corresponding channel information and corresponding ADPCM status information. Here, the transmission unit refers to the number N of ADPCM output samples per channel (for example, 256 per channel) or a transmission period, and may be set or changed in advance. Here, the channel information refers to channel identifier information assigned to distinguish between the reference channel signals, the noise control channel signals, and the error channel signals. Here, ADPCM status information is information managed within the ADPCM encoder, refers to internal information of the adaptive predictor of the ADPCM encoder, and includes a value of an immediately preceding input sample of the ADPCM encoder, and an index of a quantization step size table used at a time of compressing the immediately previous input sample for each transmission unit. The immediately previous sample value may mean a first sample value in the transmission unit.

The remote ANC system may use user datagram protocol (UDP) to transmit and receive the compressed multi-signal. This is because the remote ANC system requires high transmission speed of large data rather than transmission reliability.

In the remote ANC system, the vehicle 510 constructs a UDP packet including the channel information and the ADPCM status information along with the signal compressed for each channel for each predetermined transmission unit, and transmits the constructed UDP packet to the server 520. An example of data included in a payload of the UDP packet transmitted from the vehicle to the server is as shown in Table 1.

TABLE 1
Acceleration channel 1 information, ADPCM status information,
N ADPCM samples,
Acceleration channel 2 information, ADPCM status information,
N ADPCM samples,
. . . ,
Acceleration channel R information, ADPCM status information,
N ADPCM samples,
Microphone channel 1 information, ADPCM status information,
N ADPCM samples,
Microphone channel 2 information, ADPCM status information,
N ADPCM samples,
. . . ,
Microphone channel M information, ADPCM status information,
N ADPCM samples,
Control output channel 1 information, ADPCM status information,
N ADPCM samples,
Control output channel 2 information, ADPCM status information,
N ADPCM samples,
. . . ,
Control output channel K information, ADPCM status information,
N ADPCM samples

In the remote ANC system, the server 520 parses the received UDP packet, extracts channel information, ADPCM status information, and ADPCM output samples for each channel, and restores the compressed signal of the channel based on the channel information and ADPCM status information for each channel. The server 520 may use the restored signal to update the filter coefficient of the remote adaptive filter 423. The server 520 transmits the updated filter coefficient to the vehicle 510. The server 520 may compress the updated filter coefficient and transmit the updated filter coefficient to the vehicle 510.

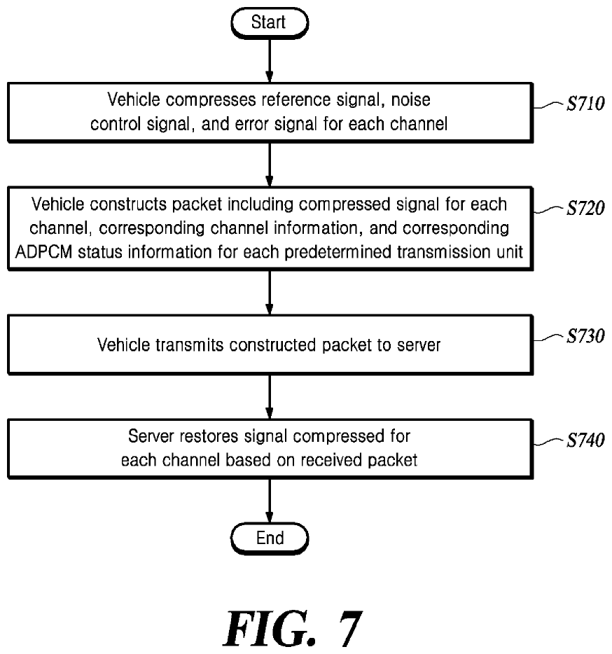

FIG. 7 is a flowchart of a method for transmitting and receiving signals between a vehicle and a server in the remote ANC system according to an exemplary embodiment of the present disclosure.

Referring to FIG. 7, the vehicle 510 compresses a multi-channel signal including at least one of the reference signal, the noise control signal, and the error signal for each channel using adaptive differential pulse code modulation (ADPCM) (S710). Here, the reference signal includes as many channels as the number (for example, R) of reference sensors 511 disposed in the vehicle 510. Here, the noise control signal includes as many channels as the number (for example, K) of speakers 513 disposed in the vehicle 510. Here, the error signal includes as many channels as the number (for example, M) of microphones 515 disposed in the vehicle 510. That is, the multi-signal may include at least one of the R reference channel signals, the K noise control channel signals, and the M error channel signals.

The vehicle constructs a packet including a signal compressed for each channel, corresponding channel information, and corresponding ADPCM status information for each predetermined transmission unit (S720). Here, the predetermined transmission unit refers to the preset number of ADPCM output samples per channel or transmission period. Here, the channel information refers to channel identifier information assigned to distinguish each of at least one reference signal, at least one noise control signal, and at least one error signal. Here, the ADPCM status information is information managed within the ADPCM encoder included in the vehicle, and includes a value of an immediately previous input sample and an index of a quantization step size table used at a time of compressing the immediately previous input sample for each transmission unit.

The vehicle transmits the constructed packet to the server (S730). The vehicle may transmit the constructed packet to the server using user datagram protocol (UDP).

The server restores the signal compressed for each channel based on the received packet (S740). The server may parse the received packet to extract the channel information, the ADPCM status information, and the ADPCM output samples for each channel. Thereafter, the server may restore the compressed signal of the channel based on the channel information and the ADPCM status information extracted for each channel.

The server may further perform a process of updating the filter coefficients of the remote adaptive filter 423 using the restored signal. The server may further include a process of transmitting the updated filter coefficient to the vehicle.

Various implementations of the systems and techniques described herein may be implemented by digital electronic circuits, integrated circuits, field programmable gate arrays (FPGAs), application specific integrated circuits (ASICs), computer hardware, firmware, software, and/or a combination thereof. These various implementations may include being implemented in one or more computer programs executable on a programmable system. The programmable system includes at least one programmable processor (which may be a special purpose processor or a general purpose processor) coupled to receive data and instructions from, and transmit data and instructions to, a storage system, at least one input device, and at least one output device. Computer programs (also known as programs, software, software applications or code) include instructions for a programmable processor and are stored on a “computer-readable recording medium.”

The computer-readable storage medium includes all kinds of storage devices that store data readable by a computer system. The computer-readable storage medium may include non-volatile or non-transitory medium such as ROM, CD-ROM, magnetic tape, floppy disk, memory card, hard disk, magneto-optical disk, and storage device, and also further include a transitory medium such as a data transmission medium. Moreover, the computer-readable storage medium may be distributed in computer systems connected through a network, and computer-readable codes may be stored and executed in a distributed manner.

In the flowcharts in the present specification, it is described that each process sequentially occurs, but this is merely an example of the technology of an exemplary embodiment of the present disclosure. In other words, a person including ordinary skills in the art to which an exemplary embodiment of the present disclosure pertains may make various modifications and variations by changing the orders described in the flowcharts in the present specification or by undergoing one or more of the processes in parallel within the essential characteristics of an exemplary embodiment of the present disclosure, so the flowcharts in the present specification are not limited to a time-series order.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operably may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A method for transmitting and receiving a multi-channel signal between a vehicle and a server in a remote active noise cancelling (ANC) system, the method comprising:
compressing, by at least one processor of the vehicle, the multi-channel signal including at least one reference signal, at least one noise control signal, and at least one error signal for each channel using adaptive differential pulse code modulation (ADPCM);
constructing, by the at least one processor of the vehicle, a packet including a signal compressed for each channel, corresponding channel information, and corresponding ADPCM status information, for each predetermined transmission unit;
transmitting, by the at least one processor of the vehicle, the constructed packet to a server; and
restoring, by the server, the signal compressed for each channel based on the received packet.

2. The method of claim 1, wherein the predetermined transmission unit is a preset number of ADPCM output samples per channel or a preset transmission period.

3. The method of claim 1, wherein the channel information is channel identifier information assigned to distinguish the at least one reference signal, the at least one noise control signal, and the at least one error signal.

4. The method of claim 1, wherein the ADPCM status information is information managed within an ADPCM encoder included in the vehicle, and includes a value of an immediately previous input sample and an index of a quantization step size table used at a time of compressing the immediately previous input sample for each transmission unit.

5. The method of claim 1, wherein the constructed packet is transmitted to the server using user datagram protocol (UDP).

6. The method of claim 1, wherein the restoring includes:
parsing, by the server, the received packet to extract the channel information, the ADPCM status information, and ADPCM output samples for each channel; and
restoring, by the server, the corresponding compressed signal of the channel based on the channel information and the ADPCM status information extracted for each channel.

7. The method of claim 1, further including:
updating, by the server, filter coefficients of a remote adaptive filter using the restored signal; and
transmitting, by the server, the updated filter coefficients to the vehicle.

8. An apparatus for transmitting a multi-channel signal included in a vehicle in a remote active noise cancelling (ANC) system, the apparatus comprising:
a memory configured to store instructions; and
at least one processor, wherein the at least one processor executes the instructions to:
compress the multi-channel signal including at least one reference signal,
at least one noise control signal, and at least one error signal for each channel using adaptive differential pulse code modulation (ADPCM),
construct a packet including a signal compressed for each channel, corresponding channel information, and corresponding ADPCM status information for each predetermined transmission unit, and
transmit the constructed packet to a server.

9. The apparatus of claim 8, wherein the predetermined transmission unit is a preset number of ADPCM output samples per channel or a preset transmission period.

10. The apparatus of claim 8, wherein the channel information is channel identifier information assigned to distinguish the at least one reference signal, the at least one noise control signal, and the at least one error signal.

11. The apparatus of claim 8, wherein the ADPCM status information is information managed within an ADPCM encoder included in the vehicle, and includes a value of an immediately previous input sample and an index of a quantization step size table used at a time of compressing the immediately previous input sample for each transmission unit.

12. The apparatus of claim 8, wherein the constructed packet is transmitted to the server using user datagram protocol (UDP).

13. An apparatus for receiving a multi-channel signal included in a server in a remote active noise cancelling (ANC) system, the apparatus comprising:
a memory configured to store instructions; and
at least one processor, wherein the at least one processor executes the instructions to:
receive packets from at least one vehicle, and
restore a signal compressed for each channel based on the received packets.

14. The apparatus of claim 13, wherein the at least one processor is further configured to:
parse the received packet to extract channel information, ADPCM status information, and ADPCM output samples for each channel, and
restore the corresponding compressed signal of the channel based on the channel information and the ADPCM status information extracted for each channel.

15. The apparatus of claim 13, wherein the at least one processor is further configured to:
update filter coefficients of a remote adaptive filter using the restored signal,
transmit the updated filter coefficients to a corresponding vehicle among the at least one vehicle.

16. The apparatus of claim 14, wherein the channel information is channel identifier information assigned to distinguish at least one reference signal, at least one noise control signal, and at least one error signal of the multi-channel signal.

17. The apparatus of claim 14, wherein the ADPCM status information is information managed within an ADPCM encoder included in the at least one vehicle, and includes a value of an immediately previous input sample and an index of a quantization step size table used at a time of compressing the immediately previous input sample for each transmission unit.

18. The apparatus of claim 14, wherein each of the packets including a signal compressed for each channel, corresponding channel information, and corresponding ADPCM status information for each predetermined transmission unit is transmitted to the server using user datagram protocol (UDP) from the at least one vehicle.
